(19) United States
(12) Patent Application Publication
(10) Pub. No.: US 2010/0307278 A1
(43) Pub. Date: Dec. 9, 2010

(54) DEVICE FOR HANDLING AND/OR PERFORMING WORK OPERATIONS ON OBJECTS

(75) Inventor: Paolo Mignano, Correggio (IT)

Correspondence Address: Pearne & Gordon LLP, 1801 East 9th Street, Suite 1200, Cleveland, OH, 44114-3108, US

(73) Assignee: MOTOR POWER COMPANY S.R.L., 42024 CASTELNOVO SOTTO (REGGIO EMILIA) (IT)

(21) Appl. No.: 12/739,515

(22) PCT Filed: Nov. 26, 2007
(86) PCT No.: PCT/IT2007/000820

§ 371 Date: Apr. 23, 2010

(51) Int. Cl. B25J 18/00; B25J 5/02

(52) U.S. Cl. 74/490.03

(57) ABSTRACT

A device for handling and/or performing work operations on objects comprises a first arm (2) and a second arm (3) each exhibiting a first end (2a, 3a) and a second end (2b, 3b); a support body (4) to which the first arm (2) and the second arm (3) are connected; means for supporting and moving (5) associated to the second ends (2b, 3b) of the first arm (2) and the second arm (3); and at least a first linear electric motor (6a) and at least a second linear electric motor (6b), each associated to a respective arm (2, 3) to produce movement thereof.

### TECHNICAL FIELD

The invention relates to a device for handling and/or performing work operations on objects.

In particular, the invention is applicable in the industrial sector in movement systems of small-mass objects weighing a few kilograms, and for which fast and precise movement is required.

### BACKGROUND ART

The invention is applicable in systems for gathering and positioning products, known as “pick and place” systems, in lines of packaging or assembly of products, in machines for separating and/or sorting products or in object to handling systems.

In the specific case, the present invention can be used in the medical field for moving and handling surgical instruments, or in the field of mechanical working for moving tools such as millers, drill bits, pliers or the like, or for the movement and training of precision instruments in general, such as for example lasers.

As is known, these systems use robot arms composed of a plurality of hinged link mechanisms, which at an end thereof bear a tool, such as pliers, a sucker or any other work instrument.

In particular, in pick and place applications, the object, located on a horizontal plane or on a conveyor belt is gathered and moved, parallel to the work plane or with its orientation changed with respect to the plane, to be deposited internally of a special housing or a second conveyor belt.

Robot architectures developed in the prior art are essentially of two types: arms of the traditional type (generally anthropomorphic) or robots having parallel kinematics mechanisms.

Both of these solutions use, in general terms, traditional actuators, typically constituted by an electric motor coupled to a mechanical reducer which adapts the torque-speed characteristics to those required by the application, usually by reducing the number of revolutions and raising the torque value. The limitations of anthropomorphic structures are essentially constituted by the fact that the actuators are distributed along the kinematic chain constituting the arm, thus involving considerable masses in movement and limiting the dynamics of the operation and consequently the working speed of the whole production line. It is worth remembering that the work speeds required are in the order of 200 collections per minute for each arm. However, the traditional structures exhibit larger work volumes and in general require control algorithms which are simpler to realise.

Parallel kinematics machines obviate the above-described dynamic limitation by concentrating all the actuators in the robot zone which remains fixed, transferring the movement to the object via a complex mechanical structure of mechanical links, often comprising more than one arm, which is however light and rigid.

Though this method gives high dynamic levels, parallel kinematics robots only enable a contained work volume to be carried out. Further, the presence in the work volume of no-go zones to be avoided during functioning in order not to cause the structure to block further reduces the useful working zone. Lastly, the complexity of the structure considerably complicates the realisation of the control algorithms.

For both solutions there is the limitation of having to provide the actuators with mechanical reducers which apart from constituting an additional cost, complicate the maintenance operations, make the structure less rigid, increase noise and vibration in the system, reduce system reliability and complicate control processes.

The aim of the present invention is to obviate the drawbacks encountered in the solutions of the prior art.

In particular, the aim of the present invention is to realise a device for handling and/or performing work operation on objects which combine the to work volumes characteristic of anthropomorphic structures with the high-level dynamics and precision of parallel kinematics machines.

In other words, an aim of the present invention is to realise a device for handling and/or the performance of work operations on objects which enables a reduction in the masses in motion, in particular in the zone closest to the object, enabling performance-giving dynamics, a decidedly large work volume and an extremely simple control structure.

Further, another aim of the present invention is to realise a device for handling and/or performing work operations on objects provided with a simplified kinematic structure, being without supplementary mechanical organs such as reducers, screw systems, systems for conversion of motion from circular to straight etc., thus leading to a reduction in costs, greater system reliability, better control of force and torque and extremely simplified control algorithms.

### DISCLOSURE OF INVENTION

A description will now be made, by way of non-limiting example, of a preferred but not exclusive embodiment of a handling device for objects, illustrated in the accompanying figures of the drawings, in which:

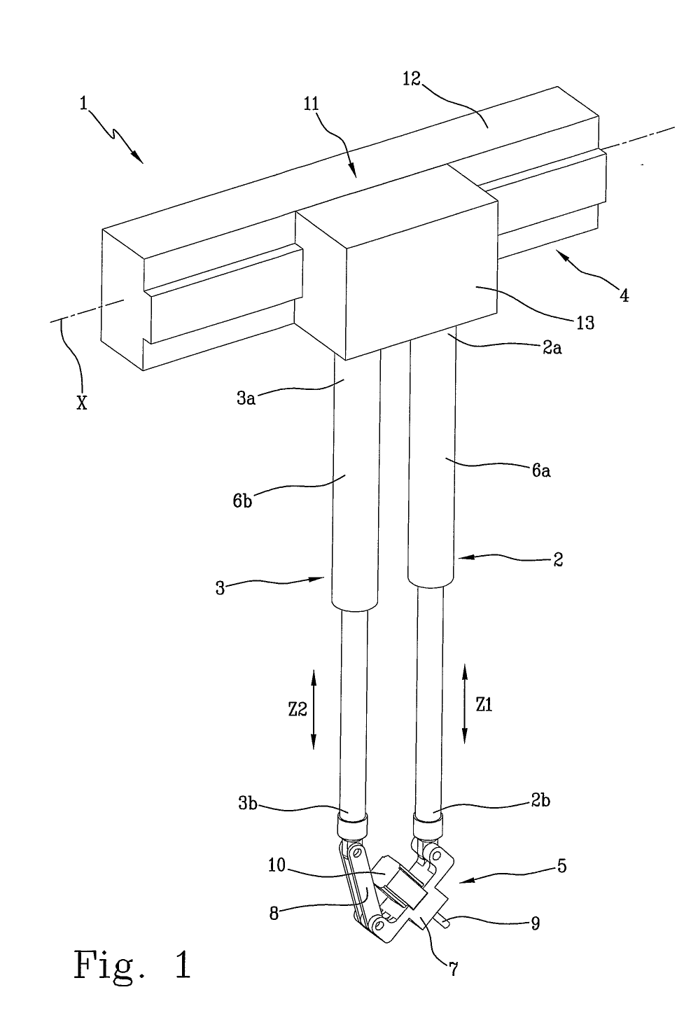

FIG. 1 is a perspective view of a device for handling objects, according to the present invention;

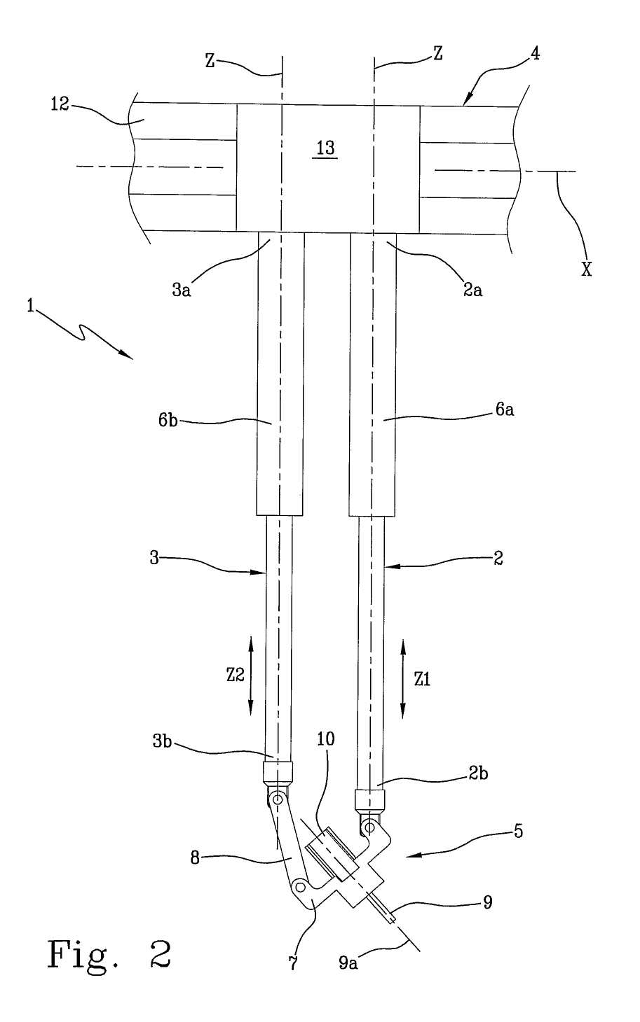

FIG. 2 is a front view of a detail of the device of FIG. 2;

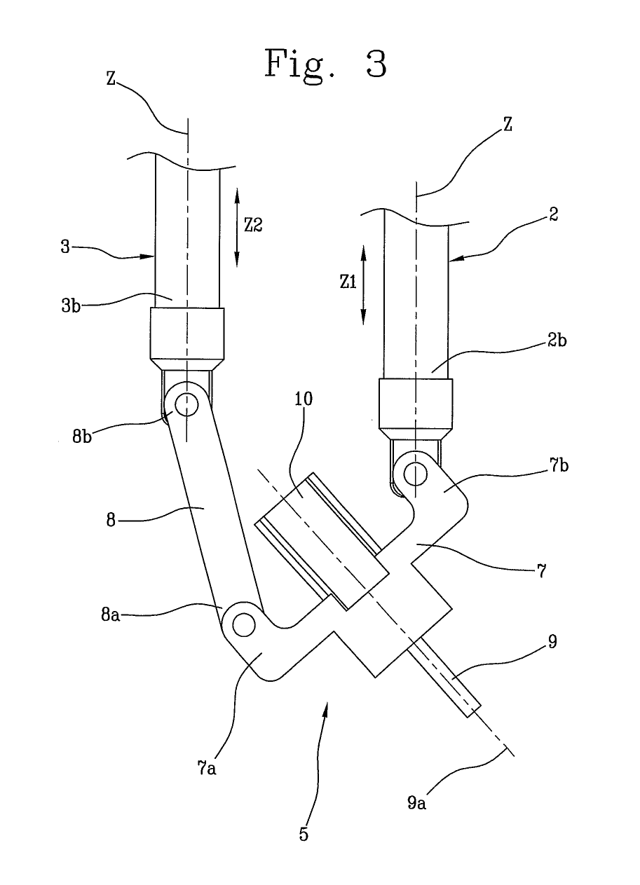

FIG. 3 is an enlarged view of a detail of FIG. 2.

With reference to the figures of the drawings, 1 denotes a device for handling and/or performing work operations on objects in accordance with the present invention.

The device 1 comprises a first arm 2 and a second arm 3, each exhibiting a first end 2a, 3a and a second end 2b, 3b.

The arms 2, 3 are advantageously straight and develop along a respective longitudinal axis Z. The axes Z of the two arms 2, 3 are preferably parallel to one another.

To lighten the device, the first arm 2 and the second arm 3 are preferably made of carbon.

The device 1 further comprises a support body 4 to which both the first arm 2 and the second arm 3 are connected by the respective first ends 2a, 3a thereof. The device 1 exhibits, associated to the second ends 2b, 3b of each arm 2, 3, means for supporting and moving 5. The means for supporting and moving 5 are preferably designed to support and move a tool 9.

The device 1 comprises at least a first linear electric motor 6a and a second linear electric motor 6b, respectively associated to the first arm 2 and the second arm 3, which move the arm 2, 3 to which they are associated.

In particular, each linear motor 6a, 6b moves the respective arm 2, 3 along a straight sliding direction Z1, Z2.

The sliding directions Z1, Z2 of the arms 2, 3 are preferably parallel to one another, and even more preferably are parallel to the axis Z of the two arms 2, 3.

The sliding direction of the first arm 2 is independent of the sliding movement of the second arm 3.

The first and second arms 2, 3, activated by the respective linear electric motors 6a, 6b, can be alternatingly mobile along the respective sliding direction Z1, Z2, or can move together.

The first and second linear electric motors 6a, 6b are preferably ironless. In ironless linear electric motors the coil is arranged between two facing tracks of permanent magnets and the flow is almost totally combined with the turns of the coil. The ferromagnetic nucleus is absent internally thereof, making the motor light.

With particular reference to FIG. 3, the means for supporting and moving 5 are preferably articulated and comprise at least a first con rod 7 and a second con rod 8, hinged to one another at respective first ends thereof 7a, 8a. The second end 7b, 8b of each con rod is hinged to a respective arm 2, 3. In particular, the second end 7b of the first con rod 7 is hinged to the second end 2b of the first arm 2, and the second end 8b of the second con rod 8 is hinged to the second end 3b of the second arm 3.

As previously mentioned, the means for supporting and moving 5 support a tool 9; in particular, the tool 9 is connected to a single con rod, for example the first con rod 7, as shown in FIG. 3.

The tool 9 can advantageously be a gripping instrument, such as pliers or a sucker, or a work tool, such as a drill, a miller, a laser or the like. In any case, any type of tool can be connected to the means for supporting and moving 5, according to needs. The first con rod 7 and the second con rod 8 define, together with the second end 2b, 3b of each arm 2, 3, a four-bar link, enabling the tool 9 to move on an arc of circumference comprised between +/−90°.

The range of the circumference swept by the tool 9 depends on design choices, and in particular on the distance between the two arms 2, 3 which is generally fixed, and by the length of the con rods 7, 8.

The movement of the tool 9 about the rotation axis 9a thereof is caused by a tradition electric motor 10, associated to the con rod bearing the tool 9.

Both the arms 2, 3 are slidably associated to the support body 4. In particular the support body 4 comprises a third linear motor 11, to which the first arm 2 and the second arm 3 are connected by respective first ends 2a, 3a thereof. The linear motor 11 therefore comprises a linear guide 12 and a slide 13 which is mobile thereon.

The first ends 2a, 3a of each arm 2, 3 are constrained to the slide 13.

The guide 12 is oriented along a direction X which is transversal, and preferably perpendicular, to the sliding direction Z1, Z2 of the arms 2, 3.

In this way the tool 9, apart from shifting along an arc of circumference, rotating about the rotation axis 9a thereof, and translating along a parallel direction to the axis Z of the arms 2, 3, can also translate along a transversal direction to the direction of the axis Z of the arms 2, 3.

The invention offers important advantages since it provides a structure having contained dimensions, which is able to manage work volumes which are characteristic of anthropomorphic structures, but with the high dynamics and precision typical of parallel kinematics machines. This is obtained by means of a non-conventional kinematic structure specially designed to be able to exploit direction-motion innovative actuators, which do not require the interposing of supplementary mechanical organs.

The linear electric motors directly command the element to which they are applied, avoiding the presence of kinematic connections which make the structure heavy, increase the amount of moving parts and slow down the working speed and the dynamics of the machine.

The special construction choice of the use of ironless linear electric motors leads to considerable advantages.

The magnetic field is symmetrical, there is an excellent exploitation of the magnetic flow, there are no forces of attraction and the mass of moving parts is small. A similar motor, though not offering high thrust levels, generally not above 2 kN, enables rapid and precise movements, optimal for pick and place applications or Cartesian robots.

The carbon arms help to lighten the device and the constructional simplicity of the linear motors simplifies the structural complexity which is typical of the devices of the prior art.

The absence of supplementary mechanical organs further enables a reduction of costs, a greater system reliability, a better control of torque force, as well as extremely simplified control algorithms.

1. A device for handling and/or performing work operations on objects, comprising: at least a first arm (2) and a second arm (3) each exhibiting a first end (2a, 3a) and a second end (2b, 3b); a support body (4) to which the first arm (2) and the second arm (3) are connected; means for supporting and moving (5) associated to the second ends (2b, 3b) of the first arm (2) and the second arm (3); wherein it comprises at least a first linear electric motor (6a) and at least a second linear electric motor (6b), each associated to a respective arm (2, 3) to produce movement thereof.

2. The device of claim 1, wherein each linear electric motor (6a, 6b) moves the respective arm (2, 3) along a straight sliding direction (Z1, Z2).

3. The device of claim 1, wherein the straight sliding directions (Z1, Z2) of the arms (2, 3) are parallel to one another.

4. The device of claim 1, wherein the arms (2, 3) are straight.

5. The device of claim 1, wherein each linear electric motor (6a, 6b) is an ironless motor.

6. The device of claim 1, wherein the first arm (2) and the second arm (3) are slidably associated to the support body (4).

7. The device of claim 6, wherein the support body (4) comprises a third linear electric motor (11) comprising a straight guide (12) and a slide (13) which is slidable on the guide (12).

8. The device of claim 7, wherein the first end (2a, 3a) of each arm (2) is constrained to the slide (13).

9. The device of claim 7, wherein the straight guide (12) is oriented in a direction (X) which is transversal to the sliding direction (Z1, Z2) of the arms (2, 3).

10. The device of claim 7, wherein the straight guide (12) is oriented in a direction (X) which is perpendicular to the sliding direction (Z1, Z2) of the arms (2, 3).

11. The device of claim 1, wherein the means for supporting and moving (5) are articulated.

12. The device of claim 11, wherein the means for supporting and moving (5) comprise at least a first con rod (7) and at least a second con rod (8), hinged to one another at a respective first end (7a, 8a) thereof and defining, with the second end (7b, 8b) of each arm (2, 3), a four-bar link.

13. The device of claim 1, wherein the means for supporting and moving (5) are destined to support a tool (9).

14. The device of claim 12, wherein at least one of the con rods (7, 8) is destined to support a tool (9).

15. The device of claim 14, wherein it comprises at least a traditional electric motor (10), associated to at least a con rod (7, 8) bearing the tool (9), to enable movement of the tool (9).

16. The device of claim 13, wherein the tool (9) is a gripping instrument.

17. The device of claim 13, wherein the tool (9) is a work tool.
